(19) United States
(12) Patent Application Publication
(10) Pub. No.: US 2015/0158037 A1
(43) Pub. Date: Jun. 11, 2015

(54) ATOMIZING NOZZLE EQUIPPED WITH FILTERING ASSEMBLY

(71) Applicant: YU CHIUNG HUANG, Taichung City (TW)

(72) Inventor: YU CHIUNG HUANG, Taichung City (TW)

(21) Appl. No.: 14/100,143

(22) Filed: Dec. 9, 2013

(51) Int. Cl. B05B 1/34; B05B 15/00

(52) U.S. Cl. CPC B05B 1/34; B05B 15/008

(57) ABSTRACT

An atomizing nozzle includes a body having an axial channel, a rotor mounted in the channel and a filtering assembly connected to the body and including a core and a filter. The core has one end being a connection end and the other end being a blocking end, and the filtering assembly has an axial inner air passage. An outlet of the air passage is disposed on the connection end. The core has a plurality of radial through holes communicating with the air passage. The filter may be fit with the connection end of the core to cover the core and to be blocked by the blocking end. The filter may be moved out of the core from the connection end. When the connection end of the core is connected to the body, the filter is restricted by the body and the blocking end and thus positioned.

### BACKGROUND OF THE INVENTION

1. Field of the Invention

The invention relates to the technology of liquid micro-atomization, and more particularly to an atomizing nozzle equipped with a filtering assembly for filtering the particles from the water.

2. Related Art

The main function of the atomizing nozzle is to form an atomized state after the liquid flows through the nozzle. Thus, either the aperture of the spray hole or the channel gap through which the liquid flows is very small. So, the particles or scale in the water tends to congest the spray hole or the water flowing channel, so that the atomizing nozzle fails or causes dripping. One solution is to replace the atomizing nozzle with a new one or clean the atomizing nozzle. The other solution is to dispose a filtering assembly in the atomizing nozzle to filter the particles from the water.

As shown in FIG. 1, a filtering assembly (12) of a known atomizing nozzle is axially mounted on a body (10). The filtering assembly (12) includes a shaft (14) and a filter (16) fit with the circumference of the shaft (14), and a plug (18) is mounted on one end of the shaft (14) to block the filter (16). When the liquid flows into the shaft (14) and then out of the filter (16), the liquid can be filtered by the filter (16) to have the higher cleanliness. The plug (18) also has the function of a rotor.

However, in order to take the filter (16) out of the shaft (14), the plug (18) is only tightly fit and positioned. After the plug is used for a period of time, the plug (18) becomes loose due to the impact force of the liquid and is thus separated from the shaft (14). Consequently, the filter (16) may move or be separated from the shaft (14) and the liquid cannot be well filtered.

As shown in FIG. 2, one end of a body (20) of another atomizing nozzle is screwed to a filtering assembly (22). The filtering assembly (22) includes a core (24) and a filter (26).

The core (24) is axially formed with an air passage (28), and formed with a radial through hole (30) communicating with the air passage (28). The filter (26) is fit with the circumference of the core (24). The core (24) has one end formed with a first stopper (32), and the other end formed with a second stopper (34). The filter (26) may be restricted by the first stopper (32) and the second stopper (34) and thus cannot be separated from the core (24).

The liquid may enter the air passage (28) inside the core (24) through the filter (26) and the through hole (30), then enter the body (20) through the air passage (28), and then be atomized by a rotor (36) and a spray hole (38).

In FIG. 2, the first stopper (32) and the core (24) have an integral main body, and the second stopper (34) and the core (24) may be formed into an integral body after the secondary machining. In other words, the filter (26) is firstly fit with the core (24), and then the second stopper (34) is riveted on one end of the core (24). Consequently, the filter (26) cannot be taken out for the purpose of replacement or cleaning after the atomizing nozzle is congested by the particles in the liquid.

### SUMMARY OF THE INVENTION

It is therefore an object of the invention to provide an atomizing nozzle equipped with a filtering assembly, in which a filter can be stably positioned and can be conveniently taken out for the purpose of replacement or cleaning.

To achieve the above-identified object and effect, the invention provides an atomizing nozzle including a body having an axial channel, a rotor mounted in the channel and a filtering assembly connected to the body and including a core and a filter. The core has one end being a connection end and the other end being a blocking end, and the filtering assembly has an axial inner air passage. An outlet of the air passage is disposed on the connection end. The core has a plurality of radial through holes communicating with the air passage. The filter may be fit with the connection end of the core to cover the core and to be blocked by the blocking end. The filter may be moved out of the core from the connection end. When the connection end of the core is connected to the body, the filter is restricted by the body and the blocking end and thus positioned.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a conventional atomizing nozzle structure.

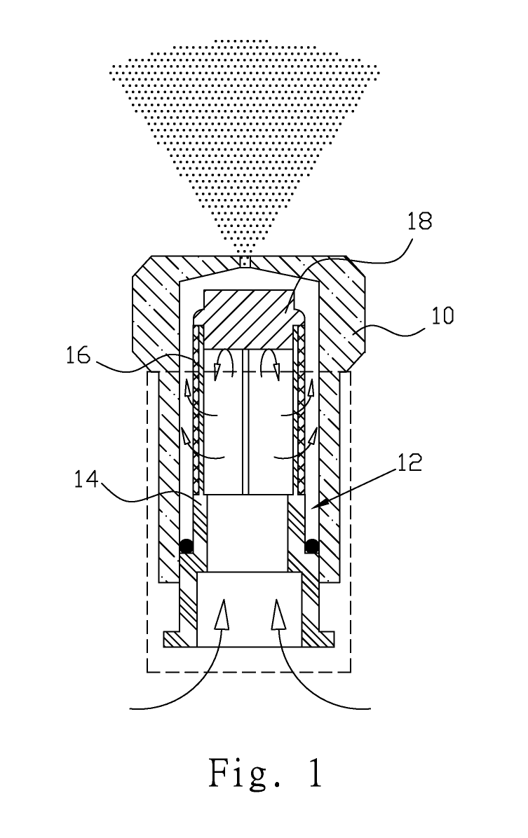

FIG. 2 is a schematic illustration showing another conventional atomizing nozzle structure.

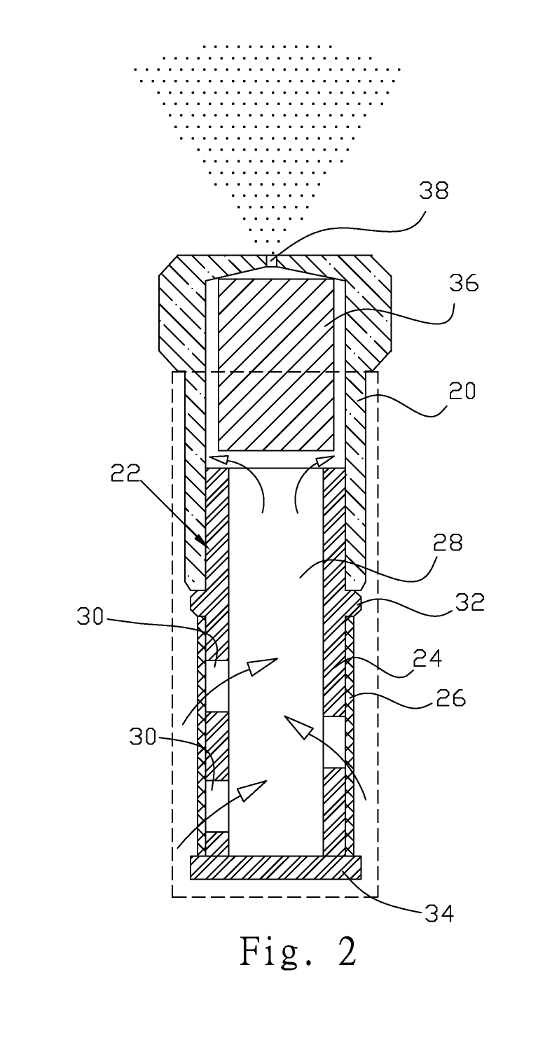

FIG. 3 is an exploded view of the invention.

FIG. 4 is a schematic illustration showing an assembled structure of the invention.

FIG. 5 is a schematic illustration showing an operation of taking out a filter of the invention.

### DETAILED DESCRIPTION OF THE INVENTION

The present invention will be apparent from the following detailed description, which proceeds with reference to the accompanying drawings, wherein the same references relate to the same elements.

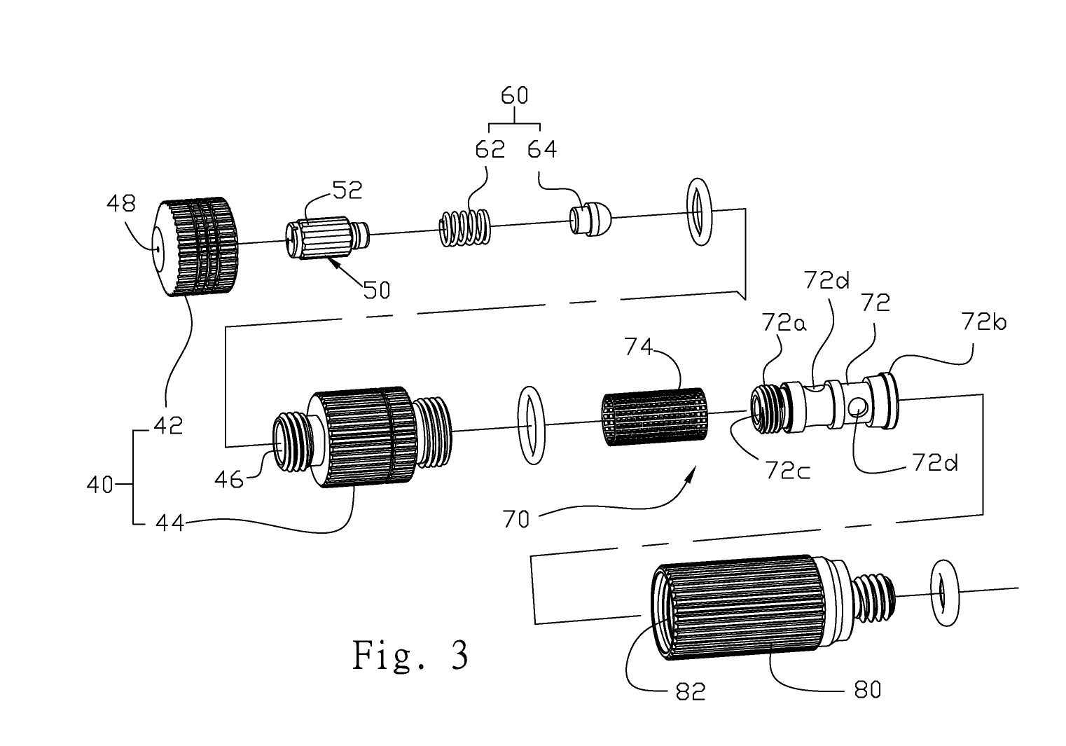

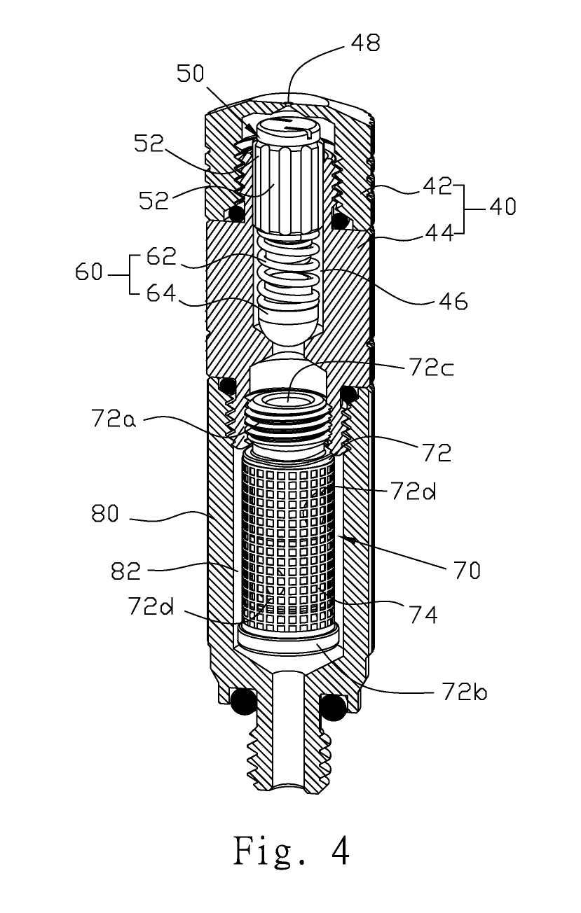

Referring to FIGS. 3 and 4, an atomizing nozzle includes a body (40), a rotor (50), a water stopping assembly (60), a filtering assembly (70) and an outer tube member (80). The body (40) may include a first member (42) and a second member (44) assembled together, and a channel (46) is formed in the body (40). The rotor (50) and the water stopping assembly (60) are mounted in the channel (46). Also, the first member (42) has an end surface formed with a spray hole (48).

Furthermore, an axial outer surface of the rotor (50) has a plurality of projecting ribs (52), and neighboring ribs (52) are parallel with each other. The water stopping assembly (60) includes a spring (62) and a ball plug (64). The spring (62) has one end connected to one end of the rotor (50), and the other end connected to the ball plug (64).

The filtering assembly (70) includes a core (72) and a filter (74). The core (72) has one end being a connection end (72a), and the other end being a blocking end (72b). The core (72) has an axial inner air passage (72c), and an outlet of the air passage (72c) is disposed on the connection end (72a). Also, the core (72) has a plurality of radial through holes (72d) communicating with the air passage (72c). The filter (74) may fit with the connection end (72a) to cover the core (72) and may be blocked by the blocking end (72b). When the connection end (72a) of the core (72) is connected to the body (40), the filter (74) is restricted by the body (40) and the blocking end (72b) and thus positioned.

Furthermore, the outer tube member (80) is axially formed in an accommodating channel (82). Two open ends of the accommodating channel (82) and the outer tube member (80) may fit with the filtering assembly (70), so that the filtering assembly (70) is disposed in the accommodating channel (82). In addition, one end of the outer tube member (80) may be connected to the body (40).

One end of the body (40) and the connection end (72a) of the core (72) of the filtering assembly (70) may be combined using threads to form a screwed combination. For example, the one end of the body (40) may have an internal thread, and the connection end (72a) of the core (72) has an external thread, so that the internal thread and the external thread may be screwed together to form the screwed combination. Similarly, the one end of the body (40) and the outer tube member (80) may be combined using threads to form another screwed combination.

Referring again to FIG. 4, when the liquid enters the accommodating channel (82) from one end of the outer tube member (80), the liquid can enter the air passage (72c) of the core (72) through the filter (74) and the through hole (72d), then flow into the channel (46) of the body (40) from one end (outlet end) of the air passage (72c), and then be sprayed from the spray hole (48) through the rotor (50) in the atomized state. Each rib (52) on the surface of the rotor (50) may abut upon the wall of the channel (46) so that the rotor (50) cannot generate the apparent deflection or displacement, and the gap between the ribs (52) may allow the clean liquid to flow through.

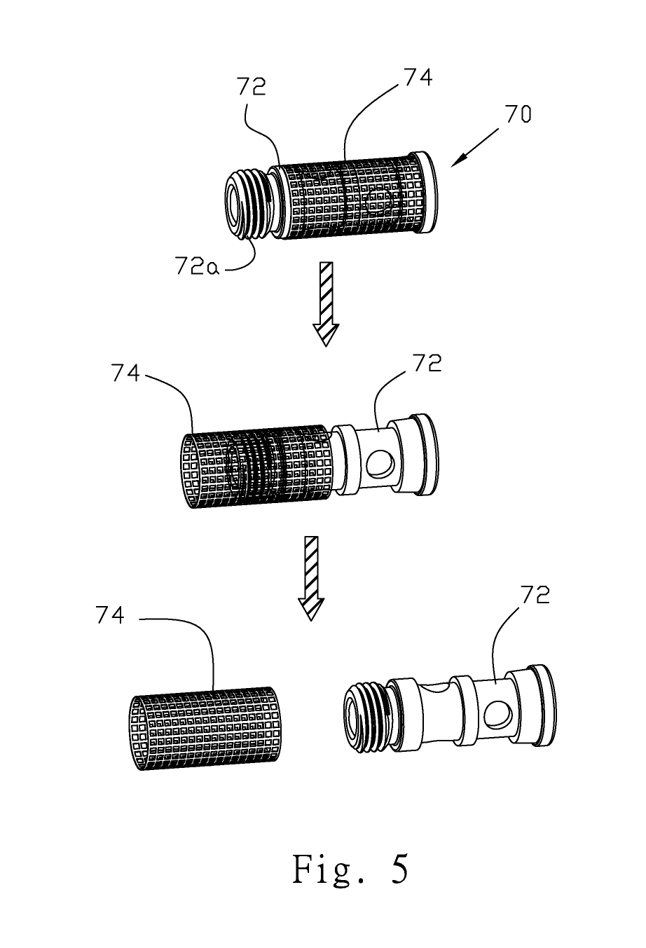

As shown in FIG. 5, when the filter (74) is to be replaced or cleaned, the filtering assembly (70) may be taken out. At this time, no blocking structure is present between the filter (74) and the connection end (72a) of the core (72). Therefore, the user may move the filter (74) toward the connection end (72a) so that the filter (74) is separated from the core (72), and this is advantageous to the replacement or cleaning of the filter (74).

Consequently, compared with the two atomizing nozzle structures of the prior art, the invention can provide the stable positioning effect to the filter (74), and provide a convenient way for the filter (74) to be taken out and thus to be replaced or cleaned.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An atomizing nozzle, comprising:
a body having an axial channel;
a rotor mounted in the channel; and
a filtering assembly comprising a core and a filter, wherein:
the core has one end being a connection end, and the other end being a blocking end, the filtering assembly has an axial inner air passage, an outlet of the air passage is disposed on the connection end, the core has a plurality of radial through holes communicating with the air passage, the filter may be fit with the connection end of the core to cover the core and to be blocked by the blocking end, and the filter may be moved out of the core from the connection end; and
when the connection end of the core is connected to the body, the filter is restricted by the body and the blocking end and thus positioned.

2. The atomizing nozzle according to claim 1, further comprising an outer tube member having an axial inner accommodating channel, wherein the accommodating channel has two open ends, the outer tube member may be fit with the filtering assembly so that the filtering assembly is disposed in the accommodating channel, and one end of the outer tube member may be connected to the body.

3. The atomizing nozzle according to claim 1, wherein one end of the body and the connection end of the core of the filtering assembly may be combined using threads to form a screwed combination.

4. The atomizing nozzle according to claim 2, wherein one end of the body and the outer tube member may be combined using threads to form a screwed combination.

5. The atomizing nozzle according to claim 1, wherein an axial outer surface of the rotor has a plurality of projecting ribs, and neighboring ribs of the projecting ribs are parallel with each other.

6. The atomizing nozzle according to claim 1, further comprising a water stopping assembly, which is mounted in the channel of the body and comprises a spring and a ball plug, wherein one end of the spring is connected to one end of the rotor, and the other end of the spring is connected to the ball plug.
